(19) United States
(12) Patent Application Publication
(10) Pub. No.: US 2011/0244219 A1
(43) Pub. Date: Oct. 6, 2011

(54) Antireflection Film for Optical Element, Antireflection Paint, and Optical Element

(75) Inventor: Reiko Kubota, Yokohama-shi (JP)

(73) Assignee: CANNON KABUSHIKI KAISHA, Tokyo (JP)

(21) Appl. No.: 13/133,261

(22) PCT Filed: Jan. 28, 2010
(86) PCT No.: PCT/JP2010/051548

§ 371 Date: Jun. 7, 2011

(30) Foreign Application Priority Data
Jan. 30, 2009 (JP) 2009-020813

(51) Int. Cl. G02B 1/11; C08K 3/22; C08K 3/08; C09D 1/00; B32B 27/18; B82Y 30/00

(52) U.S. Cl. 428/323; 524/435; 524/413; 977/773

(57) ABSTRACT

Provided is an antireflection paint for an optical element, including black primary particles and secondary particles, in which: the black primary particles each have at least a refractive index for a d line (nd) of 2.0 or more; a ratio between a maximum absorptivity of each of the black primary particles for light having a wavelength of 400 nm or more and 700 nm or less and a minimum absorptivity of each of the particles for the light is larger than 0.7; and the black primary particles have a smaller average particle diameter than an average particle diameter of the secondary particles. Such constitution can prevent surface reflection and internal reflection, absorb light in a visible region well, and alleviate an influence on an environment.

### TECHNICAL FIELD

The present invention relates to an antireflection film, and an antireflection paint (or coating or coating material), for an optical element used in an optical instrument such as a camera, a pair of binoculars, or a microscope.

### BACKGROUND ART

An antireflection film for an optical element is an antireflection film formed mainly on a surface (flange portion) except the optically effective surface of the glass of an optical element. The glass may be a lens or a prism, or may be any other optical glass.

FIG. 11 is an outline sectional view illustrating a conventional lens. As illustrated in FIG. 11, an antireflection film 31 for an optical element is formed at an arbitrary outer peripheral portion of a lens 32. When light impinges only on the lens 32 like incident light 33, the incident light 33 is transmitted as transmitted light 34. If obliquely incident light 35 is incident, the light impinges on the antireflection film 31.

If the antireflection film 31 is not formed in FIG. 11, the light 35 that has impinged on the outer periphery of the lens 32 undergoes internal reflection to be emitted as internally reflected light 36 irrelevant to an image to the outside of the lens 32. As a result, the light is responsible for a flare, a ghost, or the like, and hence the image deteriorates. When the antireflection film 31 is provided, the internal reflection for the obliquely incident light 35 can be reduced. As a result, the quantity of the internally reflected light 36 that adversely affects the image reduces, and hence the flare or the ghost can be prevented. It should be noted that the characteristics of the antireflection film 31 must be such that the refractive index of the antireflection film 31 is brought close to the refractive index of the glass of the lens 32 for reducing the internal reflection and the antireflection film 31 has a black color for absorbing light.

With the advent of a reduction in size, and an improvement in performance, of a lens, a lens having a high refractive index has been developed in recent years. An increase in refractive index has been requested of an antireflection film as well in association with the increase in refractive index of the lens.

A method involving causing the color of a coal tar itself to absorb light while increasing a refractive index with the coal tar has been described as a method of preventing internal reflection. The coal tar is effective in reducing the internal reflection because the coal tar has a high refractive index and a brownish black color. However, an alternate material to the coal tar has been demanded because an influence of a substance in the coal tar such as benzene on an environment is of concern.

Japanese Patent Application Laid-Open No. H07-82510 describes a method involving increasing a refractive index with highly refractive, black nano-fine particles as a method of preventing the internal reflection while placing emphasis on environmental protection. Japanese Patent Application Laid-Open No. H07-82510 describes a method involving increasing a refractive index with particles each having a high refractive index and black particles.

As described above, the prevention of the internal reflection requires that the refractive index of an antireflection film for an optical element be brought close to the refractive index of a glass and the antireflection film have a black color. However, the internal reflection-preventing effect of an antireflection film for an optical element using a coal tar varies with a wavelength because the coal tar has a brownish black color. In addition, there has been a growing tendency to reduce the frequency at which the coal tar is used in view of an influence on an environment.

In addition, the antireflection film for an optical element using highly refractive, black nano-fine particles described in Japanese Patent Application Laid-Open No. H07-82510 has a high internal reflection-preventing effect because its refractive index can be increased. However, when incident light 37 that impinges directly on the antireflection film of FIG. 11 is incident, the light is reflected at the surface of the antireflection film 31, and surface-reflected light 38 adversely affects an image in some cases, though such antireflection film for an optical element has a good internal reflection characteristic. A method involving adding particles to roughen the surface is available for the prevention of the surface reflection. However, when particles for preventing the surface reflection are added to the highly refractive, black nano-fine particles, there arises such problem that the refractive index of the film reduces, and hence the internal reflection exacerbates.

### DISCLOSURE OF THE INVENTION

The present invention has been accomplished in view of such background art, and an object of the present invention is to provide an antireflection film for an optical element and an antireflection paint for an optical element each of which prevents surface reflection and internal reflection, absorbs light in a visible region well, and has an alleviated influence on an environment.

An antireflection film for an optical element that solves the above problems is characterized in that the film contains at least black primary particles and secondary particles, and that the average particle diameter of the black primary particles and the average particle diameter of the secondary particles satisfy the relationship “the average particle diameter of the black primary particles<the average particle diameter of the secondary particles.”

An antireflection paint for an optical element that solves the above problems is characterized by including at least black primary particles and secondary particles, in which: the black primary particles each have at least a refractive index for a d line (nd) of 2.0 or more; a ratio between a maximum absorptivity of each of the black primary particles for light having a wavelength of 400 nm or more and 700 nm or less and a minimum absorptivity of each of the particles for the light (maximum absorptivity=minimum absorptivity) is larger than 0.7; and the primary particles have a smaller average particle diameter than an average particle diameter of the secondary particles.

Further features of the present invention will become apparent from the following description of exemplary embodiments with reference to the attached drawings.

### BRIEF DESCRIPTION OF THE DRAWINGS

FIG. 1 is an outline view of a lens on which an antireflection film for an optical element of the present invention is formed;

FIG. 2 is an outline view illustrating a placement state when black primary particles are smaller than secondary particles;

FIG. 3 is an outline view illustrating a placement state when the black primary particles are larger than the secondary particles;

FIG. 4 is an outline view illustrating a charge relationship between a substance A the surface of which is negatively charged and a substance B the surface of which is positively charged;

FIG. 5 is an outline view illustrating a charge relationship between the substances A the surfaces of which are negatively charged;

FIG. 6 is an outline view illustrating a charge relationship between the substances B the surfaces of which are positively charged;

FIG. 7 is an outline view illustrating a charge relationship among black primary particles each having a positive surface potential, secondary particles each having a negative surface potential, and a glass having a negative surface potential;

FIG. 8 is an outline view illustrating a charge relationship among black primary particles each having a negative surface potential, secondary particles each having a positive surface potential, and a glass having a positive surface potential;

FIG. 9 is a sectional view for illustrating a surface reflection-reducing function of the present invention;

FIG. 10 is a view for illustrating a method of measuring an internal reflectivity; and

FIG. 11 is an outline view of a lens on which a conventional antireflection film for an optical element is formed.

### BEST MODE FOR CARRYING OUT THE INVENTION

Hereinafter, the present invention is described in detail. An antireflection film for an optical element according to the present invention is characterized in that at least black primary particles and secondary particles are contained in the film, and that the average particle diameter of the black primary particles is smaller than the average particle diameter of the secondary particles.

An antireflection paint for an optical element according to the present invention is an antireflection paint for an optical element including at least black primary particles and secondary particles. The black primary particles each have a refractive index for a d line (nd) of 2.0 or more, and a ratio between a maximum absorptivity of each of the black primary particles for light having a wavelength of 400 nm or more and 700 nm or less and a minimum absorptivity of each of the particles for the light (maximum absorptivity=minimum absorptivity) is larger than 0.7. In addition, the primary particles have a smaller average particle diameter than an average particle diameter of the secondary particles. Furthermore, it is preferred that the black primary particles and the secondary particles be opposite in zeta potential to each other.

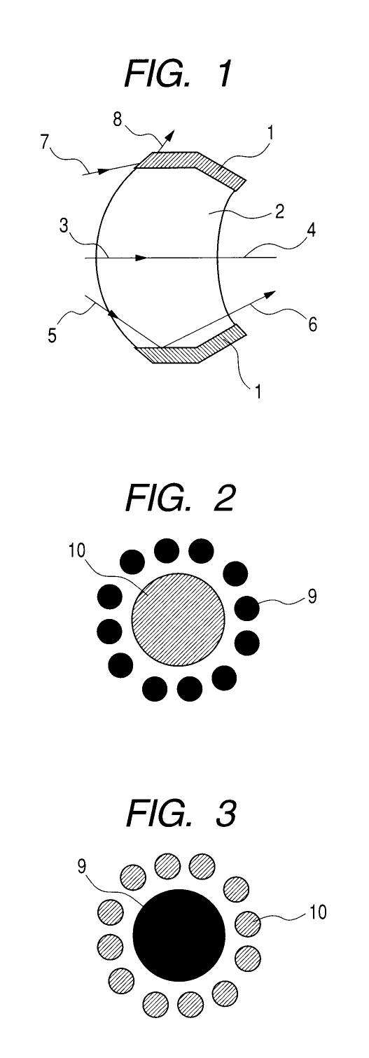

Next, the antireflection film for an optical element of the present invention is described with reference to a drawing. FIG. 1 is an outline view illustrating an example in which the antireflection film for an optical element of the present invention is formed on a lens. In the figure, reference numeral 1 represents the antireflection film, reference numeral 2 represents the lens, reference numeral 3 represents incident light, reference numeral 4 represents transmitted light, reference numeral 5 represents obliquely incident light, reference numeral 6 represents internally reflected light, reference numeral 7 represents incident light that impinges directly on the antireflection film, and reference numeral 8 represents surface-reflected light.

The antireflection film for an optical element of the present invention is an antireflection film formed mainly on an outer peripheral surface except an optical path of the glass of an optical element. Examples of the optical element include a lens, a prism, and any other optical glass.

In FIG. 1, the antireflection film 1 for an optical element is formed at the outer peripheral portion of the lens 2. When light impinges only on the lens 2 like the incident light 3, the incident light 3 is transmitted as the transmitted light 4. When the obliquely incident light 5 is incident, the light impinges on the antireflection film 1, and the internally reflected light 6 becomes the internally reflected light 6 and undergoes internal reflection. In addition, when the light 7 that impinges directly on the antireflection film is incident, the light impinges on the antireflection film 1, and the surface-reflected light 8 becomes the surface-reflected light 8.

The antireflection film for an optical element of the present invention has an internal reflection-reducing function by containing the black primary particles and the secondary particles different from each other in average particle diameter, and has a surface reflection-reducing function by containing the secondary particles having the larger average particle diameter.

First, the constitution of the internal reflection-reducing function is described. Next, the constitution of the surface reflection-reducing function is described. Finally, a material constitution for achieving those functions is described.

### (Constitution for Reducing Internal Reflection)

The average particle diameter of the black primary particles is desirably smaller than the average particle diameter of the secondary particles for reducing the internal reflection.

Hereinafter, a relationship between the average particle diameter of the black primary particles and the average particle diameter of the secondary particles is described with reference to FIGS. 2 and 3. It should be noted that the description is given by representing the average particle diameter of the black primary particles or of the secondary particles as the particle diameter of each particle for ease of description.

FIG. 2 is an outline view illustrating a particle placement state in a system where the black primary particles are smaller than the secondary particles. FIG. 3 is an outline view illustrating a particle placement state in a system where the black primary particles are larger than the secondary particles.

The average particle diameter of the black primary particles is preferably smaller than the average particle diameter of the secondary particles. Fine particles generally have such property as to adsorb to the periphery of a large particle. Accordingly, when the average particle diameter of the black primary particles is smaller than the average particle diameter of the secondary particles, black primary particles 9 are placed outside a secondary particle 10 as illustrated in FIG. 2. On the other hand, when the average particle diameter of the primary particles is larger than the average particle diameter of the secondary particles, the secondary particles 10 are placed around the black primary particle 9 as illustrated in FIG. 3. The performance of each particle placed outside is reflected more strongly in a refractive index. In contrast, the performance of the inside particle is not reflected very strongly. Accordingly, the state illustrated in FIG. 2 where the black primary particles 9 are placed outside is efficient in increasing the refractive index.

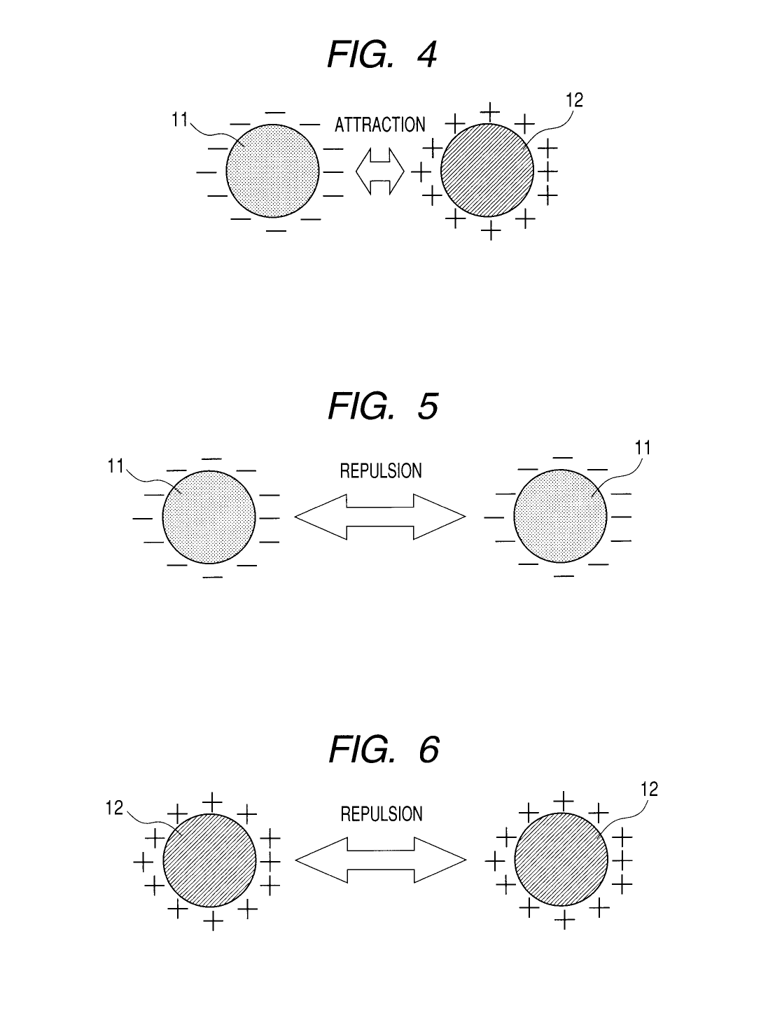

A relationship between the particle diameters of the black primary particles and the secondary particles is described in more detail with reference to FIGS. 4, 5, and 6. The very surface of a substance is charged with a positive or negative potential in a solution relative to the solution, and a value for the potential can be detected with a zeta potential. In actuality, an electric double layer is formed on the surface of the substance in the solution with respect to the charge of the substance. Furthermore, a value detected with the zeta potential is defined as a surface potential in the present invention for convenience, though the value for the potential varies depending on the potential of the solution. When a substance A11 the surface of which is negatively charged and a substance B12 the surface of which is positively charged are present in a solution, the two substances attract each other as illustrated in FIG. 4 because the positive and negative surface potentials attract each other. On the other hand, in the case of the substances A11 the surfaces of which are negatively charged as illustrated in FIG. 5, the substances depart from each other because the negative surface potentials repulse each other. In addition, in the case of the substances B12 the surfaces of which are positively charged as illustrated in FIG. 6 as well, the substances similarly depart from each other because the positive surface potentials repulse each other.

In other words, with regard to a relationship between the surface charge of each of the black primary particles and the surface charge of each of the secondary particles, it is advantageous to make the particles opposite in potential to each other as illustrated in FIG. 4 for causing the black primary particles to adsorb to the peripheries of the secondary particles. In addition, it does not matter which one of the surface charge of each of the black primary particles and the surface charge of each of the secondary particles is negative or positive.

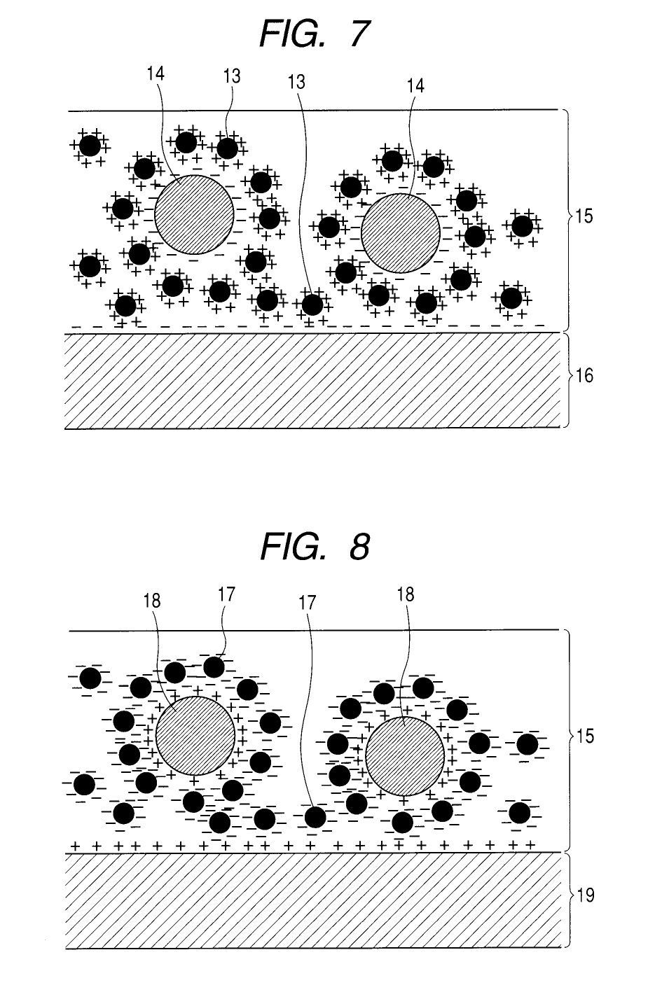

Next, a surface potential relationship when the black primary particles and the secondary particles are applied onto a glass is described. The case where the particle diameter of the black primary particle 9 is smaller than the particle diameter of the secondary particle 10 is described because the black primary particle 9 is desirably smaller than the secondary particle for an increase in refractive index as described above. A surface potential is generated on the very surface of the glass as well as the black primary particles and the secondary particles in a solution. The utilization of the surface potentials generated on the black primary particles, the secondary particles, and the glass enables the adsorption states of the particles and the glass to be controlled as well. To be specific, two patterns illustrated in FIGS. 7 and 8 are available for surface potentials desirable for the black primary particles, the secondary particles, and the glass.

First, FIG. 7 is described. In FIG. 7, black primary particles 13 each having a positive surface potential and secondary particles 14 each having a negative surface potential are present in an antireflection paint 15 for an optical element, and the antireflection paint 15 is applied onto a glass 16 having a negative surface potential. In this case, the black primary particles 13 each having a positive surface potential adsorb to the peripheries of the secondary particles 14 each having a negative surface potential, or adsorb to the glass 16 having a negative surface potential. With such form, the black primary particles tend to approach a glass interface. As a result, a refractive index at the interface of the paint increases efficiently, and hence internal reflection is reduced.

In FIG. 8, black primary particles 17 each having a negative surface potential and secondary particles 18 each having a positive surface potential are present in the antireflection paint 15 for an optical element, and the antireflection paint 15 for an optical element is applied onto a glass 19 having a positive surface potential. In this case, the black primary particles 17 each having a negative surface potential adsorb to the peripheries of the secondary particles 18 each having a positive surface potential, or adsorb to the glass 19 having a positive surface potential. With such form, the black primary particles tend to approach a glass interface. As a result, a refractive index at the interface of the paint increases efficiently, and hence internal reflection is reduced as in the case of the system of FIG. 7.

### (Constitution for Reducing Surface Reflection)

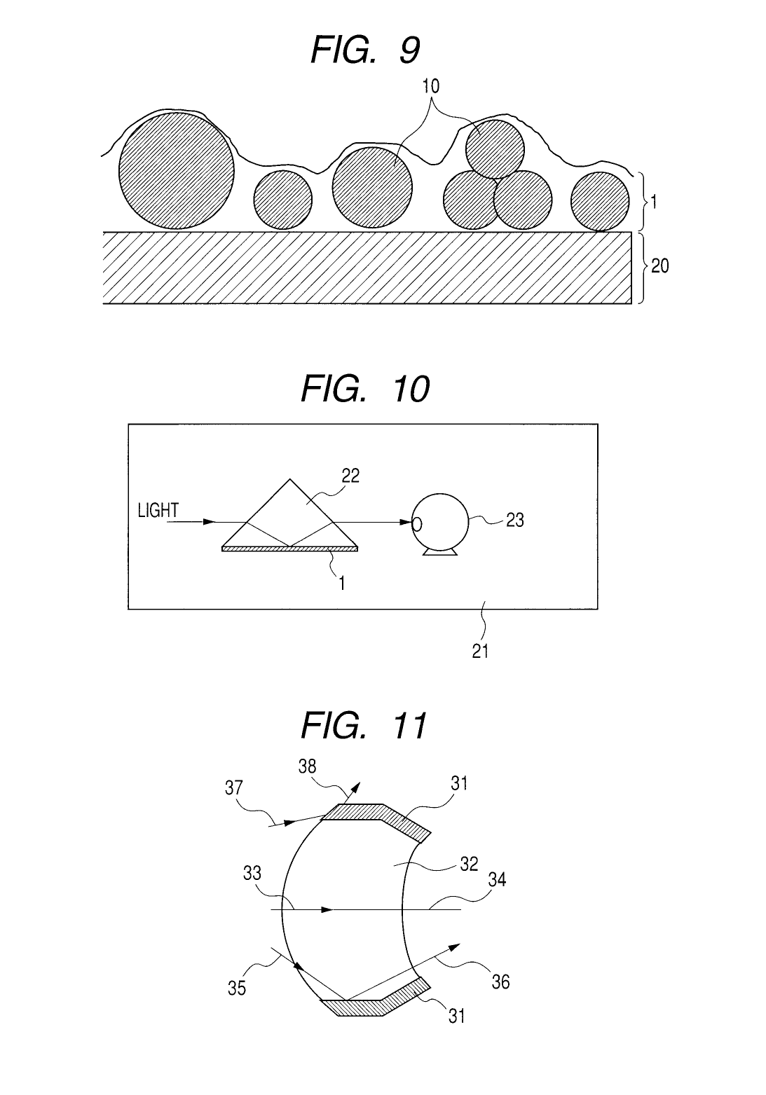

In the present invention, the surface reflection-reducing function arises by incorporating the secondary particles having the larger average particle diameter. FIG. 9 is a view for illustrating a constitution for exhibiting the surface reflection-reducing function in which an antireflection film 1 is formed on glass 20 and secondary particles 10 having a larger average particle diameter are dispersed in the antireflection film 1.

Surface reflection is reduced by the scattering of incident light with surface irregularities. Accordingly, irregularities each having a proper height must be formed for reducing the surface reflection. In the present invention, as illustrated in FIG. 9, the secondary particles 10 are preferably dispersed in the antireflection film 1 for forming the irregularities each having a proper height.

The antireflection film for an optical element of the present invention preferably has a thickness of 1 μm to 100 μm. When the thickness of the antireflection film is 1 μm or less, incident light is caused to transmit the antireflection film to undergo irregular reflection, thereby causing a flare or a ghost. When the thickness of the antireflection film is 100 μm or more, the cure shrinkage of the film increases, thereby causing the distortion of a lens or prism.

### (Components of Antireflection Paint)

An antireflection paint for an optical element according to the present invention contains at least black primary particles and secondary particles.

A material having a high refractive index is preferably used in the black primary particles. Here, the term “refractive index for a d line (nd)” in the present invention refers to a refractive index for the d line as light having a wavelength of 466.814 nm. When the refractive index is low, a refractive index difference relative to a substrate increases, and hence total reflection increases. In addition, the black primary particles each preferably absorb light in the entire visible region. When a difference in extent of absorption between arbitrary wavelengths in the visible region is large, the external appearance of the paint deteriorates.

The black primary particles each preferably have a refractive index for a d line (nd) of 2.0 or more. It is preferred that a ratio between a maximum absorptivity of each of the black primary particles for light having a wavelength of 400 nm or more and 700 nm or less and a minimum absorptivity of each of the particles for the light (maximum absorptivity÷minimum absorptivity) be larger than 0.7.

Preferred examples of the black primary particles which satisfy those characteristics include a copper-iron-manganese composite oxide and titanium black.

In addition, the black primary particles have an average particle diameter of desirably 70 nm or less, or preferably 10 nm or more and 20 nm or less. Although the particle diameter is preferably small, a realistic size is about 10 nm in view of the level of a dispersion technique. In addition, the case where the average particle diameter is larger than 70 nm is not preferable because the refractive index cannot be increased efficiently.

In addition, a material for the secondary particles is not limited as long as the material can adsorb to the periphery of each of the black primary particles. The material is preferably, for example, quartz or silica. In addition, the secondary particles have an average particle diameter of desirably 1 μm or more and 10 μm or less, or preferably 3 μm or more and 7 μm or less. When the average particle diameter is less than 1 μm, a difference between irregularities is small, and hence it becomes difficult to suppress the surface reflection. In addition, when the average particle diameter exceeds 10 μm, the surface reflection is reduced, but it becomes difficult to form a coating film accurately because a thickness varies largely.

The content of the slurry of the black primary particles in the antireflection paint is desirably 5 wt % or more and 90 wt % or less, or preferably 15 wt % or more and 80 wt % or less in the entire paint containing a solvent. Here, the slurry of the black primary particles has a concentration of 15 wt %. When the content of the black primary particles is less than 5 wt %, light is absorbed in a reduced quantity. Accordingly, light-shielding performance reduces, thereby causing a flare or a ghost. In addition, when the content is larger than 90 wt %, adhesiveness with a lens reduces.

The total content of the secondary particles in the antireflection paint is desirably 1 wt % or more and 40 wt % or less, or preferably 5 wt % or more and 20 wt % or less in the entire paint containing the solvent. When the content of the secondary particles is less than 1 wt %, the surface reflection exacerbates. In addition, when the content of the secondary particles is larger than 40 wt %, an adhesive force with a glass deteriorates.

Next, a resin is incorporated into the antireflection paint. The resin preferably has good adhesiveness with a substrate such as a glass. In addition, the refractive index of the resin itself is more preferably high for increasing the refractive index of an entire antireflection film. A material having a high refractive index and good adhesiveness with a glass is, for example, an epoxy resin. Examples of the other materials include, but not limited to, a urethane resin, an acrylic resin, a melamine resin, and vinylidene chloride.

The content of the resin in the antireflection paint is preferably 10 wt % or more and 90 wt % or less.

Next, a coupling agent for improving adhesiveness with a glass may be incorporated into the antireflection paint. Examples of the coupling agent include, but not limited to, epoxy-based silane coupling agents.

The content of the coupling agent in the antireflection paint is preferably 10 wt % or less.

Next, the solvent is incorporated into the antireflection paint. The solvent is desirably as non-polar as possible for making the surface potentials of the black primary particles and the secondary particles opposite to each other. Examples of the solvent having small polarity include, but may not be limited to, toluene, hexane, cyclohexane, xylene, 1-butanol, butyl acetate, ethyl acetate, methyl isobutyl ketone (MIBK), acetone, thinner, and ethanol.

The content of the solvent in the antireflection paint is preferably 10 wt % or more and 90 wt % or less.

Furthermore, any other component such as an antiseptic may be incorporated into the antireflection paint of the present invention as required. The content of any such component is preferably 10 wt % or less.

### (Method of Producing Antireflection Paint for Optical Element)

An antireflection film for an optical element can be obtained by curing an antireflection paint for an optical element. The antireflection paint for an optical element is produced by mixing, for example, at least slurry prepared by dispersing black primary particles in a solvent, secondary particles, and a resin. In addition, the paint may contain any other component.

A commercially available product may also be used as the slurry prepared by dispersing the black primary particles in the solvent. A method of producing the slurry is, for example, a method involving dispersing nano-fine particles with a bead mill, collision dispersing apparatus, or the like, or a method involving synthesis by a sol-gel process. In addition, an arbitrary surface treatment or dispersant may be used upon production of the slurry.

### (Components of Antireflection Film)

The antireflection film for an optical element according to the present invention is obtained by curing and drying the above antireflection paint. Therefore, the antireflection film is formed of components obtained by excluding the solvent from the components of the antireflection paint. A compounding ratio between those components is similar to a compounding ratio between the components of the antireflection paint.

### EXAMPLES

Hereinafter, suitable examples of the present invention are further described.

### Examples 1 to 9

The preparation of an antireflection paint for an optical element, the production of an antireflection film for an optical element, and evaluation for optical characteristics in each of Examples 1 to 9 were performed by the following methods.

### <Preparation of Antireflection Paint for Optical Element>

Table 1 shows the slurry of black primary particles, secondary particles, a resin, and a coupling agent of which each of antireflection paints A, B, C, D, E, F, G, and H for optical elements is formed, and a mixing ratio between the components.

It should be noted that the antireflection paint A for an optical element was used in Example 1, the antireflection paint B for an optical element was used in Example 2, the antireflection paint C for an optical element was used in Example 3, the antireflection paint D for an optical element was used in Example 4, the antireflection paint E for an optical element was used in Example 5, the antireflection paint F for an optical element was used in Example 6, the antireflection paint G for an optical element was used in Example 7, and the antireflection paint H for an optical element was used in Example 8. A method of preparing each of the antireflection paints for optical elements is as described below.

### <Preparation of Slurry of Black Primary Particles>

First, 15 g of black primary particles, 85 g of methyl isobutyl ketone (MIBK), and 3 g of a dispersant (DISPERBYK-106: BYK-Chemie) were weighed, and were then mounted in a planetary rotating apparatus (AR250; THINKY CORPORATION). The mixture was stirred for 90 minutes. As a result, 15-wt % slurry of the black primary particles was obtained. In this case, the stirring was performed under conditions of a rotation of 2000 rpm and a revolution of 66 rpm. With regard to the black primary particles of each of the antireflection paints B and C for optical elements, the slurry of the black primary particles was produced by the above preparation method.

With regard to the black primary particles of each of the antireflection paints A, D, E, F, G, and H for optical elements, particles in a slurry state were purchased.

### <Preparation of Antireflection Paint for Optical Element>

First, 90 g of the slurry of the black primary particles, 15 g of the secondary particles, 10 g of the resin, and 3 g of the coupling agent were metered and loaded into a ball mill pot. Subsequently, five magnetic balls each having a diameter of 20 mm were loaded into the ball mill pot. The slurry of the black primary particles was produced or purchased as described above. An epoxy resin (EPICOAT 828; Japan Epoxy Resins Co., Ltd.) was used as the resin. An epoxy-based silane coupling agent (KBM402; Shin-Etsu Silicone) was used as the coupling agent. The ball mill pot containing the prepared paint and the magnetic balls was set in a roll coater, and the mixture was stirred at 66 rpm for 48 hours. As a result, an antireflection paint for an optical element was obtained.

### <Measurement of Average Particle Diameter>

An average particle diameter was measured with a dynamic light-scattering apparatus (Zeta sizer Nano MPT-2; SYSMEX CORPORATION). The slurry of the black primary particles diluted with MIBK was charged into a cell, and the average of 20 values measured at 5 mV was detected. The average particle diameter was defined as a peak value in a number distribution.

### <Production of Antireflection Film for Optical Element>

First, 10 g of a curing agent were added to 118 g of the antireflection paint for an optical element, and the mixture was stirred with a roll coater for 30 minutes. An amine-based curing agent (ADEKA HARDENER EH551CH; ADEKA CORPORATION) was used as the curing agent. The stirring with the roll coater was performed under a condition of 66 rpm.

The resultant solution of the antireflection paint for an optical element and the curing agent was applied to a glass substrate or prism for evaluation so as to have a predetermined thickness, and was then dried at room temperature for 60 minutes. The antireflection paint for an optical element was dried, and was then cured in a thermostatic oven at 80° C. for 90 minutes. As a result, an antireflection film for an optical element was obtained. The antireflection film had a thickness of 10 μm.

### <Evaluation for Optical Characteristics>

### <Method of Measuring Internal Reflectivity>

An internal reflectivity was measured by placing a triangular prism 22 in a spectrophotometer 21 and passing light through the triangular prism 22 as illustrated in FIG. 10. First, light emitted from the spectrophotometer 21 passes through the triangular prism 22 to be detected by a detector 23. When no film is formed on the bottom surface of the triangular prism, absorption at the bottom surface is zero. Therefore, the internal reflectivity when each of the antireflection films A to D for optical elements was formed was measured by defining the reflectivity of a system where no film was formed on the bottom surface of the triangular prism 22 as 100%.

A method of forming an antireflection film for an optical element on the bottom surface of the triangular prism is as described above. A LaSF-03 (OHARA INC.) having a high refractive index (nd=1.8) was used as the triangular prism. In addition, with regard to the size of the triangular prism, the length of each of the sides sandwiching the right angle is 20 mm and the thickness is 10 mm. In addition, all surfaces of the triangular prism were mirror-polished. In addition, the thickness of the antireflection film for an optical element was adjusted to 10 μm or more so that no transmission might occur. In addition, the internal reflectivity was calculated by measuring internal reflectivities for light having a wavelength of 400 nm to 700 nm at an interval of 1 nm and averaging the results.

### <Method of Measuring Surface Reflectivity>

With regard to surface reflection, a reflectivity when the reflectivity of a mirror having an angle of incidence of 5° was defined as 100% was measured with a spectrophotometer.

A sample for surface reflection measurement was produced by forming an antireflection film for an optical element on a flat glass. A white glass measuring 20 mm wide by 50 mm long by 1 mm thick was used as the flat glass. The antireflection film for an optical element was formed on the upper surface of the flat glass. The thickness of the antireflection film for an optical element in this case was adjusted to 10 μm, and the average of surface reflectivities for light having a wavelength of 400 nm to 700 nm was calculated.

### <Method of Measuring Surface Roughness>

A surface roughness Ra was measured with a surface roughness meter. A sample for surface reflection measurement was produced by forming an antireflection film for an optical element on a flat glass. A white glass measuring 20 mm wide by 50 mm long by 1 mm thick was used as the flat glass. The antireflection film for an optical element was formed on the upper surface of the flat glass. The thickness of the antireflection film for an optical element in this case was adjusted to 10 μm. A length of 10 mm was subjected to the measurement with the surface roughness meter under a condition of 1 mm/sec.

### <Method of Measuring Blackness>

A blackness was calculated as shown in Eq. (1) from a ratio between the maximum absorptivity and the minimum absorptivity for light having a wavelength of 400 nm to 700 nm obtained by measuring a transmittance with a spectrophotometer. When an antireflection film has a black color, the film uniformly absorbs light in a visible region ranging from a wavelength of 400 nm to a wavelength of 700 nm. On the other hand, when the film does not absorb light having a certain wavelength in the wavelength range of 400 nm to 700 nm, the film no longer has a black color. In view of the foregoing, the blackness of the present invention was calculated as shown in Eq. (1) from a ratio between the maximum absorptivity and the minimum absorptivity for light having a wavelength of 400 nm to 700 nm. Here, the blackness is higher when the blackness is closer to 1.

Blackness=minimum absorptivity÷maximum absorptivity Eq. (1)

A sample for blackness measurement was produced by forming an antireflection film for an optical element on a flat glass. A white glass measuring 20 mm wide by 50 mm long by 1 mm thick was used as the flat glass. The antireflection film for an optical element was formed on the upper surface of the flat glass. Next, the absorptivities of the produced sample for wavelengths ranging from 400 nm to 700 nm were measured with a spectrophotometer. The thickness of the antireflection film for an optical element in this case was adjusted to 3 μm.

### <Method of Measuring Zeta Potential>

A zeta potential was measured with a dynamic light-scattering apparatus (Zeta sizer Nano MPT-2; SYSMEX CORPORATION). The measurement was performed as described below. The slurry of the black primary particles was, and the secondary particles were, diluted with MIBK. The zeta potential of each of the diluted solutions was measured at a voltage of 5 mV, and the average of 20 measured values was adopted.

<Performance when Incorporated into Lens Barrel>

Incorporation into a lens barrel was performed by forming each of all the antireflection films for optical elements in a telephoto lens. Photography was performed by setting the telephoto lens in which the antireflection film for an optical element of the present invention was formed in a camera. A photographed image was projected, and whether or not each of a flare and a ghost occurred was visually observed.

### <Results of Evaluation>

The internal reflectivity, surface reflectivity, blackness, and zeta potential of each of the films formed of the antireflection paints A, B, C, D, E, F, G, and H for optical elements were measured by the above measurement methods. Table 2 shows the results of the measurement. It should be noted that Examples 1, 2, 3, 4, 5, 6, 7, and 8 of Table 2 show the results of the measurement for the antireflection films produced by using the antireflection paints A, B, C, D, E, F, G, and H of Table 1, respectively.

As shown in Table 1, the anti-internal reflection paint A for an optical element using a copper-iron-manganese composite oxide (ZRAP15WT %-G0; C.I. Kasei Company, Limited) having a refractive index nd of 3.0 as the black primary particles was used in Example 1. As a result, all optical characteristics of the antireflection film for an optical element of Example 1 showed good values, specifically, an internal reflectivity of 3%, a surface reflectivity of 0.7%, and a blackness of 0.9. In addition, neither a flare nor a ghost was observed when image evaluation by incorporation into a lens was performed.

The anti-internal reflection paint B for an optical element using titanium black having a refractive index nd of 2 as the black primary particles was used in Example 2. As a result, all optical characteristics of the antireflection film for an optical element of Example 2 showed good values, specifically, an internal reflectivity of 11%, a surface reflectivity of 0.6%, and a blackness of 0.7. In addition, neither a flare nor a ghost was observed when image evaluation by incorporation into a lens was performed.

The anti-internal reflection paint C for an optical element using a copper-iron-manganese composite oxide (Daipyroxide TM Black #3550; Dainichiseika Color & Chemicals Mfg. Co., Ltd.) having an average particle diameter of 70 nm as the black primary particles was used in Example 3. As a result, all optical characteristics of the antireflection film for an optical element of Example 3 showed good values, specifically, an internal reflectivity of 9%, a surface reflectivity of 0.7%, and a blackness of 0.9. In addition, neither a flare nor a ghost was observed when image evaluation by incorporation into a lens was performed.

The anti-internal reflection paint D for an optical element using quartz (Crystallite AA; Tatsumori Ltd.) having an average particle diameter of 10 μm as the secondary particles was used in Example 4. As a result, all optical characteristics of the antireflection film for an optical element of Example 4 showed good values, specifically, an internal reflectivity of 2%, a surface reflectivity of 0.1%, and a blackness of 0.9. In addition, neither a flare nor a ghost was observed when image evaluation by incorporation into a lens was performed.

The antireflection paint E for an optical element to which 95 parts of particles having an average particle diameter of 100 nm had been added as the black primary particles was used in Example 5. As a result, the optical characteristics of the antireflection film for an optical element of Example 5 showed relatively good values, specifically, an internal reflectivity of 16%, a surface reflectivity of 0.7%, and a blackness of 0.9. In addition, neither a flare nor a ghost was observed when image evaluation by incorporation into a lens was performed.

The antireflection paint F for an optical element having the average particle diameter of the secondary particles adjusted to 12 μm was used in Example 6. The optical characteristics of the antireflection film for an optical element of Example 6 showed relatively good values, specifically, an internal reflectivity of 2%, a surface reflectivity of 0.1%, and a blackness of 0.9. In addition, an exacerbation of neither a flare nor a ghost was observed when image evaluation by incorporation into a lens was performed.

The antireflection paint G for an optical element using 1 part of silica having an average particle diameter of 10 nm and 14 parts of quarts having an average particle diameter of 1 μm as the secondary particles was used in Example 7. As a result, the optical characteristics of the antireflection film for an optical element of Example 7 showed relatively good values, specifically, an internal reflectivity of 22%, a surface reflectivity of 0.1%, and a blackness of 0.9. In addition, neither a flare nor a ghost was observed when image evaluation by incorporation into a lens was performed.

The antireflection paint H for an optical element using a fluorine-based resin as the resin was used in Example 8. As a result, the optical characteristics of the antireflection film for an optical element of Example 8 showed relatively good values, specifically, an internal reflectivity of 19%, a surface reflectivity of 0.7%, and a blackness of 0.9. In addition, neither a flare nor a ghost was observed when image evaluation by incorporation into a lens was performed.

TABLE 1

| | | | Anti-internal | Anti-internal | Anti-internal | Anti-internal |
|---|---|---|---|---|---|---|
| | | | reflection paint A | reflection paint B | reflection paint C | reflection paint D |
| | | | for optical element | for optical element | for optical element | for optical element |
| Anti-internal | Black | Material | Copper-iron- | Titanium black | Copper-iron- | Copper-iron- |
| reflection | particle | | manganese | | manganese | manganese |
| paint for | slurry | | composite oxide | | composite oxide | composite oxide |
| optical | | Solvent | MIBK | MIBK | MIBK | MIBK |
| element | | Particle diameter | 20 nm | 20 nm | 70 nm | 20 nm |
| | | Refractive index | 3 | 2 | 3 | 3 |
| | | (solid matter) | | | | |
| | | Manufacturer | C.I. Kasei | AKO KASEI CO., | Dainichiseika | C.I. Kasei |
| | | | Company, Limited | LTD. | Color & | Company, Limited |
| | | | | | Chemicals Mfg. | |
| | | | | | Co., Ltd. | |
| | | Model | ZRAP15WT%-G0 | TilackD | Daipyroxide TM | ZRAP15WT%-G0 |
| | | | | | Black #3550 | |
| | | Addition amount (g) | 90 | 90 | 90 | 90 |
| | Secondary | Material | Quartz | Quartz | Quartz | Quartz |
| | particles | Particle diameter | 1 μm | 1 μm | 1 μm | 10 μm |
| | | Manufacturer | Tatsumori Ltd. | Tatsumori Ltd. | Tatsumori Ltd. | Tatsumori Ltd. |
| | | Model | Crystallite 5X | Crystallite 5X | Crystallite 5X | Crystallite AA |
| | | Addition amount (g) | 15 | 15 | 15 | 15 |
| | Resin | Material | Epoxy | Epoxy | Epoxy | Epoxy |
| | | Addition amount (g) | 10 | 10 | 10 | 10 |
| | Coupling | Material | Epoxy-based | Epoxy-based | Epoxy-based | Epoxy-based |
| | agent | | silane coupling | silane coupling | silane coupling | silane coupling |
| | | | agent | agent | agent | agent |
| | | Addition amount (g) | 3 | 3 | 3 | 3 |
| | | | Anti-internal | Anti-internal | Anti-internal | Anti-internal |
| | | | reflection paint E | reflection paint F | reflection paint G | reflection paint H |
| | | | for optical element | for optical element | for optical element | for optical element |
| Anti-internal | Black | Material | Copper-iron- | Copper-iron- | Copper-iron- | Copper-iron- |
| reflection | particle | | manganese | manganese | manganese | manganese |
| paint for | slurry | | composite oxide | composite oxide | composite oxide | composite oxide |
| optical | | Solvent | MIBK | MIBK | MIBK | MIBK |
| element | | Particle diameter | 100 nm | 20 nm | 20 nm | 20 nm |
| | | Refractive index | 3 | 3 | 3 | 3 |
| | | (solid matter) | | | | |
| | | Manufacturer | Dainichiseika | C.I. Kasei | C.I. Kasei | C.I. Kasei |
| | | | Color & | Company, Limited | Company, Limited | Company, Limited |
| | | | Chemicals Mfg. | | | |
| | | | Co., Ltd. | | | |
| | | Model | Daipyroxide TM | ZRAP15WT%-G0 | ZRAP15WT%-G0 | ZRAP15WT%-G0 |
| | | | Black #9550 | | | |
| | | Addition amount (g) | 95 | 90 | 95 | 95 |
| | Secondary | Material | Quartz | Quartz | Silica/Quartz | Quartz |
| | particles | Particle diameter | 1 μm | 12 μm | 10 nm/1 μm | 1 μm |
| | | Manufacturer | Tatsumori Ltd. | Tatsumori Ltd. | NIPPON AEROSIL | Tatsumori Ltd. |
| | | | | | CO., LTD./ | |
| | | | | | Tatsumori Ltd. | |
| | | Model | Crystallite 5X | Crystallite 5X | AEROSIL 200/ | Crystallite 5X |
| | | | | | Crystallite 5X | |
| | | Addition amount (g) | 15 | 15 | 1/14 | 15 |
| | Resin | Material | Epoxy | Epoxy | Epoxy | Fluorine-based |
| | | | | | | acryl |
| | | Addition amount (g) | 5 | 10 | 5 | 5 |
| | | | — | — | — | — |
| | | | — | — | — | — |
| | | | — | — | — | — |
| | Coupling | Material | Epoxy-based | Epoxy-based | Epoxy-based | Epoxy-based |
| | agent | | silane coupling | silane coupling | silane coupling | silane coupling |
| | | | agent | agent | agent | agent |
| | | Addition amount (g) | 3 | 3 | 3 | 3 |

TABLE 2

| | | | Example 1 | Example 2 | Example 3 | Example 4 | Example 5 | Example 6 | Example 7 | Example 8 |
|---|---|---|---|---|---|---|---|---|---|---|
| Evaluation | Internal reflectivity | | 3% | 11% | 9% | 2% | 16% | 2% | 22% | 19% |
| for | Surface reflection | Surface roughness | 3 μm | 3 μm | 3 μm | 7 μm | 3 μm | 10 μm | 10 μm | 3 μm |
| optical | | Surface reflectivity | 0.7% | 0.6% | 0.7% | 0.1% | 0.7% | 0.1% | 0.1% | 0.7% |
| character- | Blackness | | 0.9 | 0.7 | 0.9 | 0.9 | 0.9 | 0.9 | 0.9 | 0.9 |
| istics | Zeta potential | Black particles | +37 mV | +9 mV | +27 mV | +37 mV | +5 mV | +37 mV | +37 mV | +37 mV |
| | | Secondary particles | −5 mV | −5 mV | −5 mV | −5 mV | −5 mV | −3 mV | −39 mV | −5 mV |

### Comparative Examples 1 to 3

The preparation of an antireflection paint for an optical element, the production of an antireflection film for an optical element, and evaluation for optical characteristics in each comparative example were each performed in the same manner as in each of Examples 1 to 8. Differences from Examples 1 to 8 are described below.

Table 3 shows the slurry of black primary particles or a coal tar, secondary particles, a resin, and a coupling agent in each of antireflection paints I, J, and K for optical elements, and a mixing ratio between the components.

Comparative Examples 1, 2, and 3 of Table 4 show the results of the evaluation of antireflection films produced by using the antireflection paints I, J, and K for optical elements of Table 3 for their optical characteristics, respectively.

The antireflection paint I for an optical element using a coal tar instead of the slurry of the black primary particles was used in Comparative Example 1. The coal tar is a brownish material, and hence absorbs a sufficient quantity of light having a wavelength of around 400 nm to 600 nm but a small quantity of light having a wavelength of around 700 nm. As a result, the antireflection film for an optical element of Comparative Example 1 had a low blackness. Accordingly, the film showed a relatively bad internal reflectivity at longer wavelengths of 29%, though the film showed a good internal reflectivity at shorter wavelengths. It should be noted that the measurement of a zeta potential was not performed because the coal tar was not particles. In addition, a flare or ghost was slightly observed at a visual observation level when image evaluation by incorporation into a lens was performed.

The antireflection paint J for an optical element using a coal tar and a black dye instead of the slurry of the black primary particles was used in Comparative Example 2. As a result, the antireflection film for an optical element of Comparative Example 2 had a low blackness. Accordingly, the film showed a relatively bad internal reflectivity at longer wavelengths of an average of 28%, though the film showed a good internal reflectivity at shorter wavelengths. It should be noted that the measurement of a zeta potential was not performed because the coal tar and the dye were not particles. In addition, a flare or ghost was slightly observed at a visual observation level when image evaluation by incorporation into a lens was performed.

The antireflection paint K for an optical element using silica having an average particle diameter adjusted to 10 nm as the secondary particles was used in Comparative Example 3. When the secondary particles are excessively small, silica adsorbs to the periphery of each of the black primary particles owing to a deteriorated zeta potential relationship between them. Accordingly, a refractive index does not increase. As a result, the antireflection film for an optical element of Comparative Example 3 had a bad internal reflectivity of 30%. In addition, a flare or ghost slightly exacerbated when image evaluation by incorporation into a lens was performed.

TABLE 3

| | | | Anti-internal reflection | Anti-internal reflection | Anti-internal reflection |
|---|---|---|---|---|---|
| | | | paint I for optical element | paint J for optical element | paint K for optical element |
| Anti- | Coal tar and | Material | Coal tar | Coal tar | Copper-iron-manganese |
| internal | black particle | | | | composite oxide |
| reflection | slurry | Solvent | MIBK | MIBK | MIBK |
| paint for | | Particle diameter | — | 20 nm | 20 nm |
| optical | | Refractive index (solid | 1.8 | 1.8 | 3 |
| element | | matter) | | | |
| | | Manufacturer | — | — | C.I. Kasei Company, |
| | | | | | Limited |
| | | Model | Tarcron 180 | Tarcron 180 | ZRAP15WT%-G0 |
| | | Addition amount | 90 | 90 | 90 |
| | | (g) | | | |
| | Secondary | Material | Quartz | Quartz | Silica |
| | particles | Particle diameter | 1 μm | 1 μm | 10 nm |
| | | Manufacturer | Tatsumori Ltd. | Tatsumori Ltd. | NIPPON AEROSIL CO., |
| | | | | | LTD. |
| | | Model | Crystallite 5X | Crystallite 5X | AEROSIL 200 |
| | | Addition amount | 15 | 15 | 15 |
| | | (g) | | | |
| | Resin | Material | Epoxy | Fluorine-based acryl | Epoxy |
| | | Addition amount | 10 | 10 | 5 |
| | | (g) | | | |
| | Dye | Material | — | Black dye EXBP | — |
| | | Manufacturer | — | ORIENT CHEMICAL | — |
| | | | | INDUSTRIES CO., LTD. | |
| | | Addition amount | — | 5 | — |
| | | (g) | | | |
| | Coupling | Material | Epoxy-based silane | Epoxy-based silane | Epoxy-based silane |
| | agent | | coupling agent | coupling agent | coupling agent |
| | | Addition amount | 3 | 3 | 3 |
| | | (g) | | | |

TABLE 4

| | | | Comparative | Comparative | Comparative |
|---|---|---|---|---|---|
| | | | Example 1 | Example 2 | Example 3 |
| Evaluation for | Internal reflectivity | | 29% | 28% | 30% |
| optical | Surface reflection | Surface roughness | 3 μm | 3 μm | 0.1 μm |
| characteristics | | Surface reflectivity | 0.5% | 0.5% | 6.0% |
| | Blackness | | 0.3 | 0.6 | 0.9 |
| | Zeta potential | Black particles | — | — | +37 mV |
| | | Secondary particles | −5 mV | −5 mV | −42 mV |

The present invention can provide an antireflection film for an optical element and an antireflection paint for an optical element each of which prevents surface reflection and internal reflection, absorbs light in a visible region well, and has an alleviated influence on an environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-020813, filed Jan. 30, 2009, which is hereby incorporated by reference herein in its entirety.

1.-10. (canceled)

11. An antireflection film for an optical element, comprising:
a resin;
black primary particles contained in the resin; and
secondary particles contained in the resin and having a larger average particle diameter than an average particle diameter of the black primary particles.

12. The antireflection film for an optical element according to claim 11, wherein:
the black primary particles each have a refractive index for a d line (nd) of 2.0 or more; and
a ratio between a maximum absorptivity of each of the black primary particles for light having a wavelength of 400 nm or more and 700 nm or less and a minimum absorptivity of each of the particles for the light is larger than 0.7.

13. The antireflection film for an optical element according to claim 11, wherein the black primary particles each comprise one of a copper-iron-manganese composite oxide and titanium black.

14. The antireflection film for an optical element according to claim 11, wherein the average particle diameter of the black primary particles is 10 nm or more and 70 nm or less.

15. The antireflection film for an optical element according to claim 11, wherein the average particle diameter of the secondary particles is 1 μm or more and 10 μm or less.

16. An antireflection paint for an optical element, comprising:
a resin;
black primary particles contained in the resin; and
secondary particles contained in the resin,
wherein:
the black primary particles each have at least a refractive index for a d line (nd) of 2.0 or more;
a ratio between a maximum absorptivity of each of the black primary particles for light having a wavelength of 400 nm or more and 700 nm or less and a minimum absorptivity of each of the particles for the light is larger than 0.7; and
the black primary particles have a smaller average particle diameter than an average particle diameter of the secondary particles.

17. The antireflection paint for an optical element according to claim 16, wherein the black primary particles and the secondary particles are opposite in zeta potential to each other.

18. An optical element, comprising:
a glass substrate; and
an antireflection film formed on a surface of the glass substrate,
wherein the antireflection film comprises a resin, black primary particles contained in the resin, and secondary particles contained in the resin and having a smaller average particle diameter than an average particle diameter of the black primary particles.

19. The optical element according to claim 18, wherein:
the black primary particles each have at least a refractive index for a d line (nd) of 2.0 or more; and
a ratio between a maximum absorptivity of each of the black primary particles for light having a wavelength of 400 nm or more and 700 nm or less and a minimum absorptivity of each of the particles for the light is larger than 0.7.

20. The optical element according to claim 18, wherein the surface of the glass substrate comprises a surface except an optically effective surface of the glass substrate.
